(19) United States
(12) Patent Application Publication
(10) Pub. No.: US 2008/0168399 A1
(43) Pub. Date: Jul. 10, 2008

(54) USER INTERFACE FACILITATING CONTROL IN A VIRTUAL THREE-DIMENSIONAL ENVIRONMENT

(76) Inventor: Michael Hetherington, Williamston, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/970,935

(22) Filed: Jan. 8, 2008

Related U.S. Application Data
(60) Provisional application No. 60/883,873, filed on Jan. 8, 2007.

(51) Int. Cl. G06F 3/048

(52) U.S. Cl. 715/856

(57) ABSTRACT

A computer interface makes it easier to control a 3D virtual device on a display screen with a 2D pointing device such as a mouse. A virtual device having an associated movement and underlying function is rendered on a display screen. A cursor is moved to the device, and if it is selected, a graphical user interface (GUI) is displayed including a control icon with the cursor automatically pre-positioned in relation to the control icon. If the control icon is adjusted the virtual device is moved on the display screen and the function associated with the device is performed. Upon de-selection of the device the GUI disappears from the display screen. In the preferred embodiment, the cursor is moved with a mouse and the device is selected with a mouse button. The cursor is then automatically positioned in overlapping registration with the control icon upon the selection of the device. The control icon may be a slider, knob, switch or any other type of implement appropriate to the control of the virtual device. The invention is particularly useful in controlling devices such as forward-back levers wherein at least a portion of the movement of the device is visualized as into or out of the display screen.

### REFERENCE TO RELATED APPLICATION

This application claims priority from U.S. Provisional Patent Application Ser. No. 60/883,873, filed Jan. 8, 2007, the entire content of which is incorporated herein by reference.

### FIELD OF THE INVENTION

This invention relates generally to human-computer interfaces and, in particular, to an interface that facilitates 2D manipulation of 3D controls in a virtual environment.

### BACKGROUND OF THE INVENTION

Computer games and training materials are now being created using virtual 3D environments requiring a user to navigate and interact in various ways. In such environments, the user's perspective is often set at various angles to virtual surfaces and the user may approach a virtual object from any angle. This makes it very difficult with the 2D interface such as a mouse to manipulate certain virtual objects such as control levers, switches, doors or latches and other things that in the real world require careful manipulation, with the hands, for example.

As one example, there is no intuitive way to “pull” a lever toward the user with a 2D mouse. Additionally, a user new to the specific virtual 3D experience may not know how the object is to be manipulated to achieve a desired effect. Another problem with existing interfaces is that the size of a virtual object may change as the user gets closer. When a virtual object that needs to be controlled is far away the range of motion required to manipulate the object is very small.

Overall, there are many disadvantages of manipulating virtual 3D controls with a 2D interface such as a mouse. For example, a user may have to guess how a 2D mouse movement will affect the control, particularly if the user is viewing the control at an oblique angle. The control may have to be “pushed” or “pulled” directly into the screen, and the control may be partially blocked by some other object. Twisting action such as with a rotary knob is very difficult to perform with a mouse. Objects may be too small to allow significant mouse movement to move the control. Depending on the virtual distance from the object, the scale will may be different over time, and 3D objects male it difficult to label various useful information such as current level and range of the control.

### SUMMARY OF THE INVENTION

This invention makes it easier to control a 3D virtual device on a display screen with a 2D pointing device such as a mouse, thereby creating an interface that is intuitively simple for anyone who has operated standard 2D type interface.

According to the method, a virtual device having an associated movement and underlying function is rendered on a display screen. A cursor is moved to the device, and if it is selected, a graphical user interface (GUI) is displayed including a control icon with the cursor automatically pre-positioned in relation to the control icon. If the control icon is adjusted the virtual device is moved on the display screen and the function associated with the device is performed. Upon de-selection of the device the GUI disappears from the display screen.

In the preferred embodiment, the cursor is moved with a mouse and the device is selected with a mouse button. The cursor is then automatically positioned in overlapping registration with the control icon upon the selection of the device. The control icon may be a slider, knob, switch or any other type of implement appropriate to the control of the virtual device. In addition to the control icon, the GUI may further display text, the current value of the underlying function of the device, or other useful information.

The cursor preferably remains in the same position on the display screen when the GUI is displayed. However, if the device is close to, or overlapping with, the peripheral edge of the display screen, the GUI and pre-positioned cursor may be shifted on the display screen for complete visualization. The cursor also preferably remains in the same position on the display screen when the GUI disappears, though it may in some cases snap back to its original position at device selection prior to device movement.

Though not limited in this regard, the invention is particularly useful in controlling devices of the type wherein at least a portion of the movement of the device is visualized as into or out of the display screen. Such devices would include levers and switches that move forward and back, virtual flight yokes, upwardly oriented knobs and horizontally oriented steering wheels such as those found on busses. Following de-selection of the device, it may either remain in its moved position on the display screen or it may return to the position it was in prior to being moved in accordance with the underlying function. For example, the horn lever on a virtual train would move back up after being pulled, whereas a gear-shift lever would remain in position after shifting.

### BRIEF DESCRIPTION OF THE DRAWINGS

FIG. 1 is a diagram that shows a cursor moved to a 3D device to be controlled, in this case a lever to be pulled down;

FIG. 2 shows a pop-up 2D interface under the cursor, in this case a slider;

FIG. 3 shows how the lever is “pulled down” as the user manipulates the 2D slider;

FIG. 4 shows how the 2D pop-up disappears following control of the 3D device;

FIG. 5 is a detail diagram of the 2D pop-up of FIG. 2;

FIG. 6 is a detail diagram of the 2D pop-up of FIG. 3;

FIG. 7 is a drawing that shows the selection of a device at the edge of the display with only a portion of the device showing; and

FIG. 8 shows how the cursor and 2-D pop-up interface are shifted so that a user can better visualize the control process.

### DETAILED DESCRIPTION OF THE INVENTION

This invention significantly reduces confusion associated with manipulating 3D objects in virtual environments. According to the preferred method, a user “clicks” on an object in the environment with a mouse. If the object has an associated underlying function, a pop-up 2D graphical user interface (GUI) instantly appears under the cursor with an active, appropriate 2D control. Thus, in a single click, a control GUI appears, positioned automatically in relation to the cursor, and ready to perform the function associated with the object.

The user's attention is not distracted because the mouse cursor—the user's current visual point of focus-does not jump. The user is also not required to perform more than a single click and hold for most functions. In the preferred embodiment, after the user releases the mouse button the pop-up dialog disappears. In cases where the pop-up dialog would be forced to appear partially off the screen, the dialog and mouse will be moved so that the dialog appears completely on the screen.

As the 2D control is adjusted, the 3D control is animated to change corresponding to the values set by the 2D control. This animation of the 3D control can occur in real time, when the dialog is still visible or after the mouse is released depending on the type of control.

The invention is applicable to simple controls such as levers or knobs and also to more complicated events such as unlocking a box, uncoupling a train car, or on latching then throwing a lever. Unique to the invention is the integration of the selection of the 3D object, the appearance of the 2D pop-up, and the automatic selection of the proper 2D control in the active state. This reduces the entire experience for the user to a single click. In most other pop-up systems the user clicks, and a pop-up with several choices appears, the user then slides the mouse over to one of them to select that. It is a several-step process, often resulting in a confusing interface.

The instant appearance and disappearance of the pop-up window corresponding to the 3D object on appearance and disappearance on release of the mouse from the 2D control is novel as well. The real-time adjustment of the 3D lever or object corresponding to the 2D control is an important feedback that dramatically simplifies system operation.

### HORN LEVER EXAMPLE

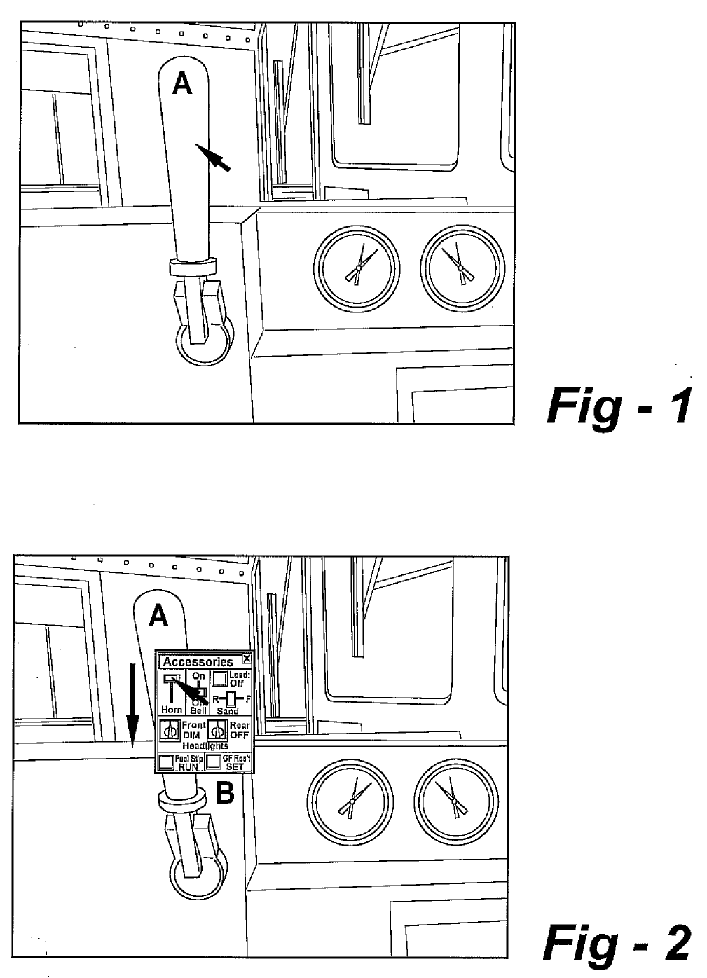

The horn lever in an American Locomotive will be used as an example. This lever is pulled toward the locomotive engineer to sound the horn. FIG. 1 is a diagram that shows a cursor arrow moved to the lever (A) to be pulled down. As shown in FIG. 2, when the user clicks and holds the mouse button on the 3D lever object (A), a pop-up dialog box (B) appears directly under the cursor, The dialog box is automatically positioned so that the relevant 2D slider control (C) is also directly under the cursor. The user does not have to move the mouse to instantly gain access to the proper control. The 2D slider is a standard type of GUI control that is clear to the user how to operate.

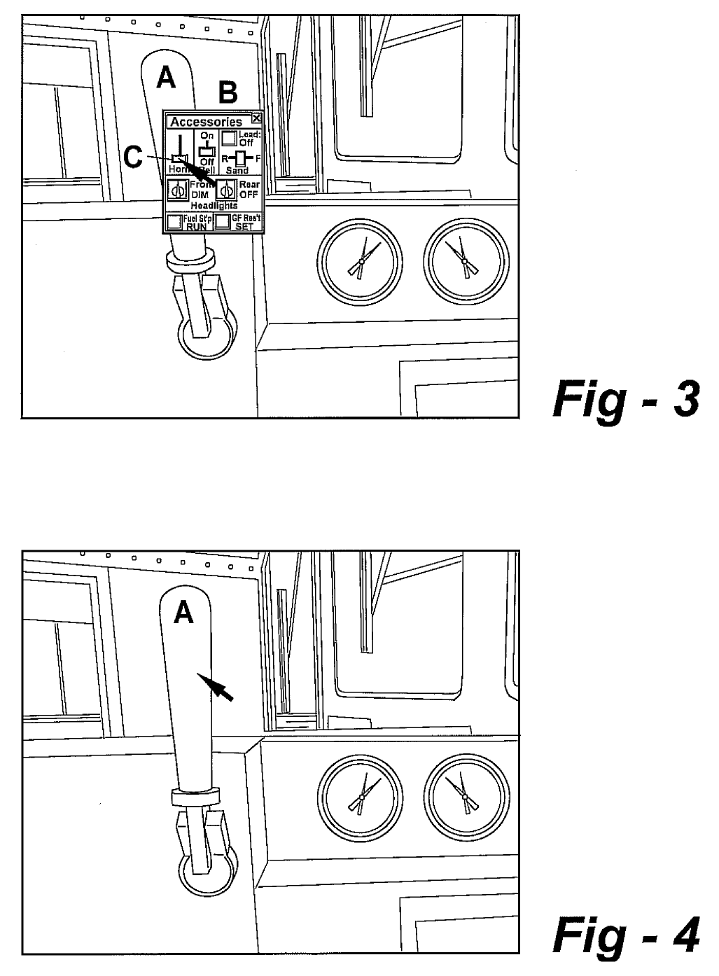

As shown in FIG. 3, the 2D slider control (C) is immediately active without any further clicking, the user only must slide the mouse cursor down to control the horn. The direction of the mouse motion required is immediately obvious due to the orientation of the standard GUI 2D type control. The 3D lever object (A) is animated to move as it would in the 3D environment, in and out of the screen in this case.

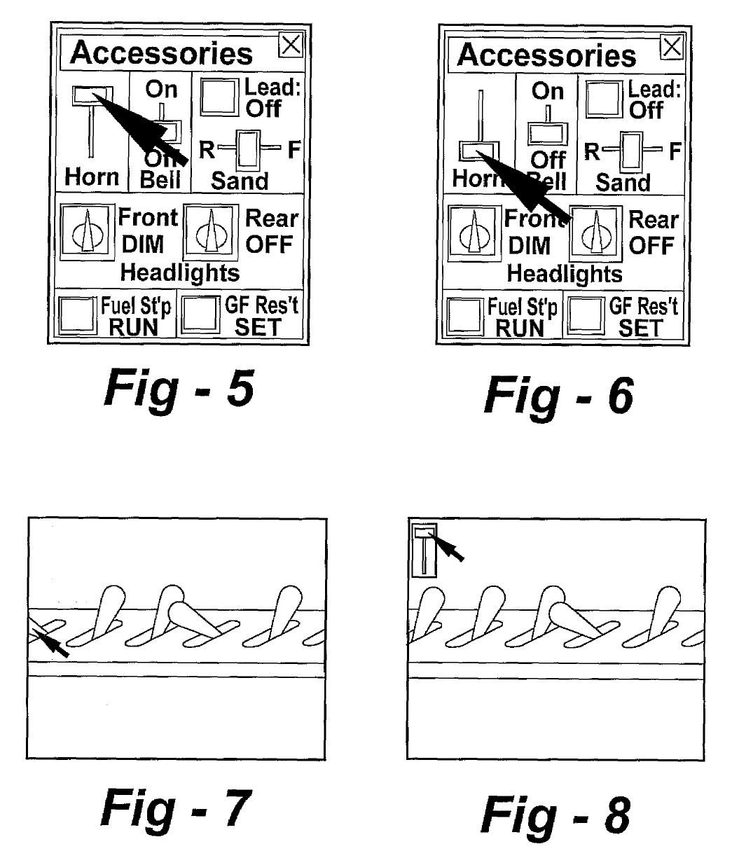

When the mouse button is released the Dialog automatically disappears, as shown in FIG. 4. The 3D control lever (A) is in the appropriate position for the state that was set with the 2D slider. The user is ready to use the mouse again. No additional actions are required. FIG. 5 is a detail diagram of the 2D pop-up of FIG. 2, and FIG. 6 is a detail diagram of the 2D pop-up of FIG. 3.

FIG. 7 is a drawing that shows the selection of a device at the edge of the display with only a portion of the device showing. FIG. 8 shows how the cursor and 2-D pop-up interface may be shifted in this case so that a user can better visualize the control process. FIG. 8 also shows how the 2D control may be dedicated to the function of the selected device, thereby simplifying the pop-up as compared to the interfaces of FIGS. 5 and 6.

I claim:

1. A method of controlling a graphical device in a virtual environment, comprising the steps of:
displaying a virtual device having an associated movement and underlying function on a display screen having a peripheral edge;
moving a cursor to the device;
selecting the device;
automatically displaying a graphical user interface (GUI) upon the selection of the device, the GUI including a control icon with the cursor pre-positioned in operative relation to the control icon;
adjusting the control icon with the cursor if desired, thereby causing the virtual device to move and perform the function; and
de-selecting the device, thereby causing the GUI to disappear from the display screen.

2. The method of claim 1, wherein the cursor is automatically positioned in overlapping registration with the control icon upon the selection of the device.

3. The method of claim 1, wherein cursor is moved with a mouse.

4. The method of claim 1, wherein:
cursor is moved with a mouse; and
the device is selected with a mouse button.

5. The method of claim 1, wherein the control icon is a slider.

6. The method of claim 1, wherein the GUI further displays text, the current value of the associated function, or other useful information.

7. The method of claim 1, wherein the cursor does not move when the GUI is displayed.

8. The method of claim 1, wherein the GUI and pre-positioned cursor are shifted on the display screen if the device is close to, or overlapping with, the peripheral edge of the display screen.

9. The method of claim 1, wherein the cursor does not move when the device is de-selected.

10. The method of claim 1, wherein at least a portion of the associated movement of the device is visualized as into or out of the display screen.

11. The method of claim 1, wherein the device remains in its moved position on the display screen following de-selection.

12. The method of claim 1, wherein the device returns to the position it was in prior to being moved on the display screen following de-selection.

13. The method of claim 1, wherein the device is a virtual lever.

14. A computer interface, comprising:
a display screen;
a display generator operative to render a virtual device having an associated movement and underlying function on the display screen;
a mouse operative to move a cursor to the device on the display screen and select the device, whereupon the display generator automatically displays a graphical user interface (GUI) including a control icon with the cursor pre-positioned in operative relation to the control icon, enabling a user to adjust the control icon with the cursor to move the virtual device and perform the function, with the GUI disappearing from the display screen upon de-selection of the device.

15. The computer interface of claim 14, wherein the display generator causes the cursor to be automatically positioned in overlapping registration with the control icon upon the selection of the device.

16. The computer interface of claim 14, wherein the control icon is a slider or other two-dimensional control icon.

17. The computer interface of claim 14, wherein the virtual device is a lever or other three-dimensional virtual device.
